(19) United States
(12) Patent Application Publication
(10) Pub. No.: US 2010/0146071 A1
(43) Pub. Date: Jun. 10, 2010

(54) OUTBOUND BROADBAND CONNECTIVITY

(75) Inventors: Timothy N. Comerford, Indianapolis, IN (US); Jerry L. Proffitt, Wabash, IN (US); Priya Bhatt, Fort Wayne, IN (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: Carrier Corporation, Farmington, CT (US)

(21) Appl. No.: 12/521,474

(22) PCT Filed: Dec. 29, 2006
(86) PCT No.: PCT/US06/49615

§ 371 Date: Feb. 8, 2010

(51) Int. Cl. G06F 15/16; G05D 23/19

(52) U.S. Cl. 709/217; 709/227; 700/276

(57) ABSTRACT

The invention relates to a method for automatically achieving outbound broadband connectivity to a remote server including the steps of sending a message to the remote server, waiting for an inbound connection request, setting an inbound method of connectivity if an inbound connection request is received, sending an outbound poll if the inbound connection request is not received, setting an outbound method of connectivity, and retrying to connect via the inbound or the outbound method until either of the inbound or outbound methods successfully connects to the remote server

### FIELD OF THE INVENTION

This invention relates generally to a method and system for establishing network connectivity between a system or device and a remote computer server, and more specifically for establishing network connectivity so that the remote server can communicate with and/or control the system or device.

### BACKGROUND OF THE INVENTION

Virtually all businesses maintain a continuous connection to the Internet, often referred to as a broadband connection. It is also increasingly common to find broadband connections in homes. Generally a broadband connection can be shared by several computers or devices. Such sharing is typically accomplished by use of a router. The router can have one broadband connection and a plurality of distribution connections. The distributed connections can be either wired connections, as by cat. 5 cabling, or by wireless connections, as by WiFi. Most routers include one or more security features, such as a firewall, to block uninvited externally generated potentially malicious or mal-intended information packets from entering computers or devices serviced by the router.

While router firewalls are important to help create secure computer networks, both in commercial and in home settings, any such security measures can also cause the installation of a new device to be problematic. For example, a customer installing a new device with Internet connectivity via a home router might find that they cannot establish full connectivity with the new device. On calling technical support at the manufacturer of the device, the consumer might be directed to call the manufacturer of the router. Then on calling technical support at the manufacturer of the router, the consumer might be directed to contact the device manufacturer for more information. Or, where the device or equipment needing internet connectivity is being installed by a commercial installer, the installing technician might not be familiar with computer related issues. In such cases, it can be cost prohibitive to the installing company to have installers dealing with a great variety of router types and router network configurations.

What is needed is a method and apparatus that can allow a device to be simply “plugged in” to a business or home wired or wireless network to achieve broadband connectivity with a remote server on its own, without further intervention.

### SUMMARY OF THE INVENTION

In one aspect, the invention relates to a method for automatically achieving outbound broadband connectivity to a remote server comprising the steps of: providing a device or system having a broadband connection; providing a broadband access; connecting the device or system to the broadband access; sending a message to the remote server to establish a connection with the remote server; closing the connection to the remote server; waiting for an inbound connection request; setting an inbound method of connectivity if an inbound connection request is received within a first allotted time; sending an outbound poll if the inbound connection request is not received within the first allotted time; setting an outbound method of connectivity if a response to the outbound poll is received from the remote server within a second allotted time; and retrying to connect via the inbound or the outbound method until either of the inbound or outbound methods successfully connects to the remote server.

In another aspect, the invention relates to an HVAC system including a HVAC plant for controlling the comfort levels in a space. The HVAC system also includes a system access module (“SAM”) to provide remote control of the HVAC plant. The SAM is electrically wired to the HVAC plant and has a broadband connection, wherein the SAM establishes connectivity to a remote computer server by first trying an inbound connection method, then trying an outbound connection and the SAM automatically chooses either the inbound connection or the outbound connection to cause the remote computer server to be communicately coupled to the SAM via the broadband connection.

In yet another aspect, the invention relates to a system for automatically connecting a device to a remote server including a broadband access point. The system also includes a microcomputer board. The microcomputer board has a broadband connection to the broadband access point, and the microcomputer board has a microcomputer programmed to automatically select an inbound or an outbound connection method to a remote computer server. The system also includes a device to be controlled by the microcomputer board. The device is electrically coupled to the microcomputer board, wherein following the automatic selection of the inbound or the outbound connection mode to the remote computer server, the remote computer server performs an action via the broadband access point.

### BRIEF DESCRIPTION OF THE DRAWINGS

For a further understanding of these and objects of the invention, reference will be made to the following detailed description of the invention which is to be read in connection with the accompanying drawing, where:

FIG. 1 shows a block diagram of an exemplary embodiment of a system or device controlled by a SAM connected via a broadband connection to a remote computer server; and

FIG. 2 shows one embodiment of a flowchart suitable to carry out automatic selection of an inbound or an outbound method to connect to a remote computer server according to the invention.

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

Internet connectivity can generally be made by connection to a distribution point on either a wired or wireless router. Some computers and devices, even after achieving a technically correct connection, such as via a wired cat. 5 Ethernet cable, or a wireless WiFi connection, still cannot work properly without further technical intervention. Such further technical intervention often involves opening a port or setting an exception to overcome router firewall issues or internet service provider (“ISP”) restrictions. Such interventions, while simple and routine to an Internet Technology (“IT”) professional can be daunting to a consumer or an installer in a non-computer related trade.

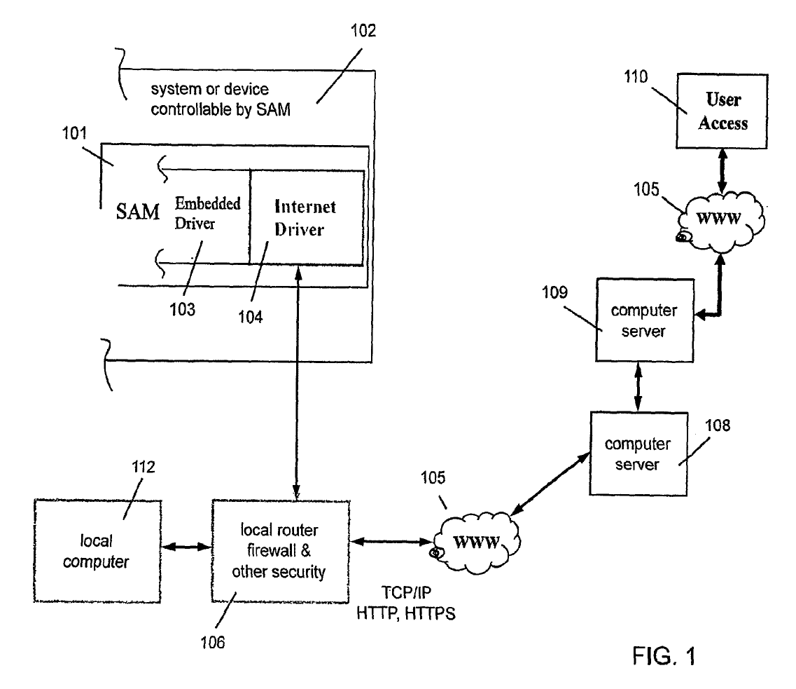

One exemplary embodiment of a system according to the invention is shown in FIG. 1. In the exemplary system embodiment of FIG. 1, the goal is to install a system or device 102 controlled by SAM 101 and to have the SAM 101 automatically connect to a particular server 108, typically a remote computer server. Once successfully communicatively connected to server 108, server 108 can control device or system 102 via SAM 101. Such control can be by real time, prearranged, and/or preprogrammed actions and events, residing on server 108, or by real time, prearranged, and/or preprogrammed actions and events communicated to server 108 from another computer, such as illustrated by exemplary server 109, another computer server, shown in FIG. 1. Moreover, a user of a device or system 102 controlled by SAM 101 can log in to a server such as server 109 and establish control over device or system 102 controlled by SAM 101 such as by a connection to the Internet as illustrated by user access block 110.

A communications module, referred to in the exemplary embodiment of FIG. 1 as a system access module (“SAM”) 101 can communicate with a device or system 102 controllable by SAM 101 such as a heating ventilation and air conditioning (“HVAC”) system. SAM 101 can be built into such a device or system or a SAM 101 can be co-located and connected to the system or device, typically by connecting wires or cables. Embedded driver 103 can perform the inventive method described below in conjunction with Internet driver 104 that performs basic TCPIP network connectivity functions. In this system embodiment, Internet driver 104 can be communicately coupled to the Internet via a local wired (typically Ethernet) or wireless (typically WiFi) connection via wired or wireless router 106. Router 106 can be connected in turn to the Internet 105 typically by a broadband connection. Any suitable type of broadband connectivity including for example, DSL, cable modem, FIOS, or hardwired connection such as a T1 line can be used. Moreover, there is no particular requirement for a router 106. Any suitable substitute broadband access connection or broadband access point can be used.

Also, while an installer of a device or system 102 controlled by SAM 101 need not be concerned with detailed setup and/or connectivity issues related to establishing communications to server 108, the mere presence of a SAM 101 on the local router 106 network can provide another convenient access point for connecting an installer or user computer 112 to SAM 101 via a local wired or wireless network, through a local wired or wireless connection to router 106. Such a connection can be conveniently made, for example, using a web browser such as Internet Explorer, Firefox, Opera, etc. SAM 101 can also present a user web interface for controlling or reading diagnostic information from device or system 102.

Using hardware having similar functionality to the exemplary system described in FIG. 1, the inventive method allows a newly connected or newly installed device or system 102 having at least an equivalent of embedded driver 103, but not necessarily a SAM 101, to automatically connect device or system 102 to server 108 via a network connection. Such a connection can typically be made via a local network router, the Internet 105, and server 108. Once connected to the local network, embedded driver 103 begins the connection process, generally by communicating in TCPIP through an Internet driver 104.

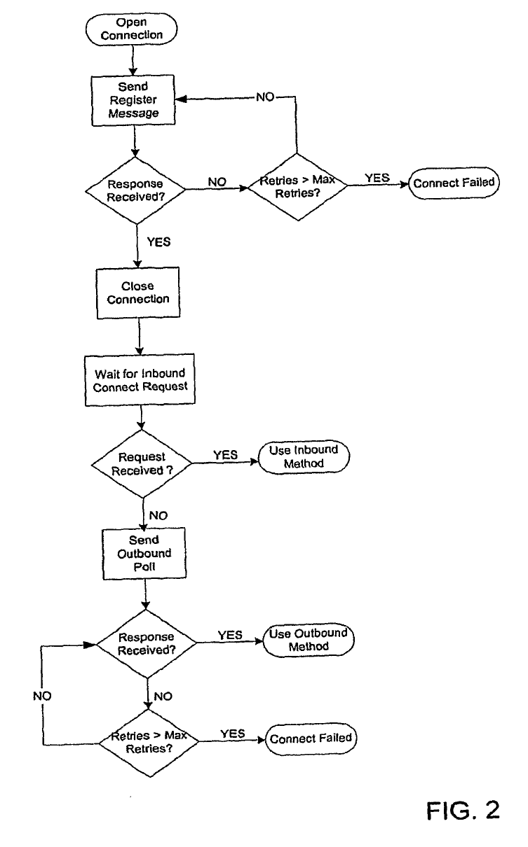

Turning now to FIG. 2, the inventive method is explained in more detail. The first programmed step is to open a network connection. Next registration is accomplished by outbound traffic sent to server 108. Following the registration process, the connection is closed. Embedded driver 103 then waits for an inbound connection request from server 108. It is this step that frustrates most conventional system and device connections to server 108, because router 106 and/or an ISP for the local broadband connection typically thwart unsolicited inbound traffic as a perceived security threat. In the exceptional case where such an inbound connection is successfully made, the “inbound” mode of communications, where server 108 can contact embedded driver 103 at will, can be selected as the preferred mode for communications. Most likely, however, the inbound connection will be automatically refused and will not work. In this second case, embedded driver 103 sends an outbound poll to server 108. Because server 108 was just polled, router 106 will allow server 108 to connect by inbound traffic from server 108. Such inbound traffic immediately following a poll request by embedded driver 103 is virtually always viewed as safe or at least as allowable solicited inbound traffic. When the second method works, the second “outbound method” is established as the preferred mode of Internet connectivity between embedded driver 103 and server 108. In the exemplary system of FIG. 1, SAM 101 has thus automatically been linked to server 108 via router 106, through the Internet 105.

In the unlikely event that the outbound method also fails, upon recognizing “connect failed”, the automatic connection routine can attempt to reconnect following a timed interval or reset sequence (not shown in FIG. 2). Such a failure could occur, for example, where an installer or user powers up a system performing the inventive method before connecting an Ethernet connection, or before installing a local area network WiFi router. It is also understood that a user might need to enter a WEP or WPA key in order to open a connection with a WiFi router. Such a basic step can be a necessity for connecting anything to a WiFi router so securely configured, and is not considered on par with needing intervention by an IT professional or computer technician as has previously been discussed with regard to opening ports or creating security and firewall exceptions.

It should be emphasized that a SAM 101 as shown in FIG. 1 was merely used to illustrate one embodiment of a system using the inventive method. The functionality of the inventive automatic routine to connect a system or device to be controlled by a server, such as server 108, by an automatically selected inbound mode or outbound mode can also be accomplished by programming any suitable computer having a network interface to perform the inventive method. Suitable computers include microcomputers, microprocessors, or any embedded microcomputer like device that can perform the functions of a computer or microcomputer. Once connected by either the inbound or the outbound connection mode, sever 108 can send periodic status queries to the system or device to be controlled by sever 108.

### Example 1

Referring to FIG. 1, System 102 is a home comfort system (such as a residential HVAC system) located in a seasonal home, such as a winter or summer home that is otherwise generally unoccupied. SAM 101 is a system access module as manufactured by the Carrier Corporation. An installer installs the home comfort system and couples control input/output connections of SAM 101 to the comfort system in a conventional manner analogous to an installation of a multifunction thermostat. Once connected to a local broadband connection, as for example, by a wired cat. 5 cable to a wired router 106, such as a wired router manufactured by the Cisco Systems Corporation, SAM 101 attempts to contact a server 108 using the first inbound method. The firewall in router 106 prevents unsolicited inbound traffic from server 108 at some later time after SAM 101 registered with server 108 and closed the connection. After about one minute, SAM 101 tries to connect via the outbound poll method and succeeds. Thereinafter, SAM 101 establishes communications with server 108 every minute via the automatically selected outbound method. At a later time following installation, the home owner of the seasonally used home in another state logs into a computer server 109 via the Internet 105. Server 109 connects to server 108 by a prearranged communication path set up by the manufacturer of the comfort system and transparent to the home owner. Using the established connection, server 108 can periodically send status inquiries the home comfort system. Thus, the homeowner's computer display can show an internet web page reflecting the temperatures and thermostat set points in the seasonally used, but presently unoccupied home. The homeowner also has the ability to change any of the temperature set points using a web page graphical user interface.

### Example 2

The SAM 101 of example 1 can have additional input/output ports for connecting to other systems or devices. For example, a basement water detector can present a digital output signal to a SAM 101 input indicating undesired water in the basement. On detecting such a digital signal, SAM 101 can then notify server 108 of the water condition and any number of optional notification events can follow, including email, phone, and similar such notifications to interested parties such as a local caretaker, a local service company, and the home owner.

### Example 3

A home owner installs a fossil fuel powered electric back up generator next to their home. The generator has an internal microcomputer based control board including an Ethernet connection that can be connected to the consumer's local wired broadband router. Once a week, the generator performs automatic maintenance checks and logs the results in local memory. On detecting a failed condition of some part of the generator back up system, the generator reports the failure to a computer server using the internet connectivity between the generator and the computer server as achieved using the inventive method. No SAM is present or needed. All of the relevant functions, such as the embedded driver and internet driver are provided on the local back up generator microcomputer control board.

The inventive method solves most security related Internet conductivity problems in spite of most existing router and ISP security restrictions. A device incorporating the inventive method of Internet device connectivity as described with respect to FIG. 1 can achieve true “plug and play” internet appliance performance generally without further need for computer expert assistance or IT intervention. The principle of operation is that most router and ISP security measures allow outbound TCPIP packet transmissions, but limits some or all of the unsolicited inbound TCPIP traffic. It can be desirable to allow asynchronous inbound traffic from a server attempting to interact with an internet device, therefore this mode of Internet connection is preferable. However, where such connectivity is precluded without further intervention, a device using the inventive method automatically switches to a second outbound mode of connection where exchanges can be initiated by the device at a periodic interval resulting in responses that are allowed by most security systems as direct TCPIP responses to outgoing router traffic to a specific server.

It should be noted that while exemplary references were made herein to wired connections using cat. 5 cables, the types of wired cable are unimportant to practicing the inventive method and system. Any suitable wireless or wired network connection can be used, including for example, wired cat. 3 connections.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method for automatically achieving outbound broadband connectivity to a remote server comprising the steps of:
providing a device or system having a broadband connection;
providing a broadband access;
connecting the device or system to the broadband access;
sending a message to the remote server to establish a connection with the remote server;
closing the connection to the remote server;
waiting for an inbound connection request;
setting an inbound method of connectivity if an inbound connection request is received within a first allotted time;
sending an outbound poll if the inbound connection request is not received within the first allotted time;
setting an outbound method of connectivity if a response to the outbound poll is received from the remote server within a second allotted time; and
retrying to connect via the inbound or the outbound method until either of the inbound or outbound methods successfully connects to the remote server.

2. The method of claim 1, further comprising a method step between the steps of setting an outbound method of connectivity and retrying to connect via the inbound or the outbound method, the further step comprising retrying to connect to the remote server via the outbound method for a maximum number of tries.

3. The method of claim 1, wherein the step of providing broadband access comprises the step of providing broadband access via a wired router.

4. The method of claim 1, wherein the step of providing broadband access comprises the step of providing broadband access via a wireless WiFi router.

5. The method of claim 1, wherein the step of providing a device or system comprises the step of providing an HVAC system having a broadband connection.

6. The method of claim 1, wherein the step of providing a device or system comprises the step of providing a backup power generating system having a broadband connection.

7. An HVAC system comprising:
a HVAC plant for controlling the comfort levels in a space; and
a system access module (“SAM”) to provide remote control of the HVAC plant, the SAM electrically wired to the HVAC plant and having a broadband connection, wherein the SAM establishes connectivity to a remote computer server by first trying an inbound connection method, then trying an outbound connection and the SAM automatically chooses either the inbound connection or the outbound connection to cause the remote computer server to be communicately coupled to the SAM via the broadband connection.

8. The HVAC system of claim 7, wherein the remote computer server is configured to accept queries about the status of the HVAC plant as well as to control the HVAC plant in response to preprogrammed events programmed on the remote computer server or communications to or from a user logged into the remote computer server.

9. The HVAC system of claim 7, wherein the broadband connection is made via a wired router.

10. The HVAC system of claim 7, wherein the broadband connection is made via a wireless WiFi router.

11. The HVAC system of claim 7, wherein the SAM is further configured to accept input output (“I/O”) information from an alarm device not part of the HVAC plant.

12. The HVAC system of claim 11, wherein the alarm device is a water alarm.

13. A system for automatically connecting a device to a remote server comprising:
a broadband access point;
a microcomputer board, the microcomputer board having a broadband connection to the broadband access point, and the microcomputer board having a microcomputer programmed to automatically select an inbound or an outbound connection method to a′remote computer server; and
a device to be controlled by the microcomputer board, the device electrically coupled to the microcomputer board, wherein following the automatic selection of the inbound or the outbound connection mode to the remote computer server, the remote computer server performs an action via the broadband access point.

14. The system of claim 13, wherein the action is to request status information from the device.

15. The system of claim 13, wherein the action is to control the device.

16. The system of claim 13, wherein the broadband access point is provided by a wired router.

17. The system of claim 13, wherein the broadband access point is provided by a wireless WiFi router.

18. The system of claim 13, wherein the device is a consumer appliance.

19. The system of claim 13, wherein the remote computer server is programmed to periodically send status queries to the device using the mode automatically selected by the automatic selection of the inbound or the outbound connection mode.

20. The system of claim 13, wherein the remote server is configured to allow a user who logs in to the remote server to control the device.
